(19) United States
(12) Patent Application Publication
(10) Pub. No.: US 2025/0156023 A1
(43) Pub. Date: May 15, 2025

(54) DISPLAY CONTROL METHOD AND APPARATUS, AND ELECTRONIC DEVICE

(71) Applicant: NETEASE (HANGZHOU) NETWORK CO., LTD., Hangzhou, Zhejiang (CN)

(72) Inventors: Shuo LIN, Hangzhou, Zhejiang (CN); Yinting LIU, Hangzhou, Zhejiang (CN)

(73) Assignee: NETEASE (HANGZHOU) NETWORK CO., LTD., Hangzhou, Zhejiang (CN)

(21) Appl. No.: 18/838,627

(22) PCT Filed: Sep. 28, 2022
(86) PCT No.: PCT/CN2022/122218

§ 371 Date: Aug. 15, 2024

(30) Foreign Application Priority Data
Apr. 26, 2022 (CN) 202210447874.6

(51) Int. Cl. G06F 3/0481

(52) U.S. Cl. CPC G06F 3/0481

(57) ABSTRACT

The present disclosure provides a display control method and apparatus, and an electronic device. The method includes: in response to a terminal screen being rotated from a first posture to a second posture, acquiring control elements on the screen under the first posture and size information of the control elements, wherein the control elements on the screen under the first posture are divided into a plurality of control groups in advance; according to size information of the control groups and the size of the screen under the second posture, determining a target control group, which needs to be adjusted, and an adjustment mode therefor; and adjusting the target control group according to the adjustment mode, and displaying the control elements on the screen under the second posture.

### CROSS REFERENCE TO RELATED APPLICATIONS

The present disclosure is a U.S. national phase application of International Application No. PCT/CN2022/122218, filed on Sep. 28, 2022, which is based upon and claims priority to Chinese Patent Application No. 202210447874.6, filed on Apr. 26, 2022 and entitled “DISPLAY CONTROL METHOD AND APPARATUS, AND ELECTRONIC DEVICE”, the entire contents of both of which are incorporated herein by reference for all purposes.

### TECHNICAL FIELD

The present disclosure relates to the field of application development technology, in particular to a display control method, a display control apparatus, and an electronic device.

### BACKGROUND

Screen interfaces for applications on mobile devices (such as smartphones, tablets, etc.) usually include multiple adapted controls that spread all over the screen. In the case where a conversion between a horizontal screen and a vertical screen of the mobile device occurs, if there are only several controls on the screen interface, the conversion between horizontal and vertical screens can be automatically adapted without any additional processing. However, if there are many controls on the screen interface, additional adjustments and processing are needed.

It should be noted that the information disclosed in the above section is only intended to enhance the understanding of the background of the present disclosure, and thus can include information that does not constitute the prior art already known to those skilled in the art.

### SUMMARY

In a first aspect, the present disclosure provides a display control method, which includes: obtaining, in response to a screen of a terminal being converted from a first posture to a second posture, control elements on the screen under the first posture and size information of the control elements, wherein a size of the screen under the first posture along a specified axis and a size of the screen under the second posture along the specified axis are different, the control elements on the screen under the first posture are pre-divided into multiple control groups, and each control group includes at least one of the control elements; determining, based on size information of the control group and the size of the screen under the second posture, a target control group that needs to be adjusted and an adjustment approach for the target control group; and adjusting the target control group according to the adjustment approach for the target control group, to display the control elements on the screen under the second posture based on display positions of the multiple control groups after being adjusted.

In a second aspect, the present disclosure provides an electronic device including a processor and a memory, wherein the memory stores computer executable instructions that can be executed by the processor, and the processor executes the computer executable instructions to cause the display control method as described in the first aspect to be implemented.

In a third aspect, the present disclosure provides a non-transitory computer-readable storage medium, which stores computer executable instructions. When the computer executable instructions are called and executed by a processor, the computer executable instructions cause the processor to implement the display control method as described in the first aspect.

It should be understood that the general description in the above and the detailed description in the following are only illustrative and explanatory, and do not limit the present disclosure.

### BRIEF DESCRIPTION OF THE DRAWINGS

In order to provide clearer explanations of specific embodiments of the present disclosure or technical solutions in the prior art, a brief introduction to the drawings required in the specific embodiments or the description of the prior art will be given in the following. It is apparent that the drawings in the following are some of the embodiments of the present disclosure, and for those skilled in the art, other drawings can be obtained based on these drawings without creative efforts.

FIG. 1 is a schematic diagram of a screen conversion according to one or more embodiments of the present disclosure;

FIG. 2 is a flowchart of a display control method according to one or more embodiments of the present disclosure;

FIG. 3 is a schematic diagram of a posture conversion of a screen of a terminal according to one or more embodiments of the present disclosure;

FIG. 4 is a schematic diagram of adjusting a child control element according to one or more embodiments of the present disclosure;

FIG. 5 is a schematic diagram of a structure of a display control apparatus according to one or more embodiments of the present disclosure; and

FIG. 6 is a schematic diagram of a structure of an electronic device according to one or more embodiments of the present disclosure.

### DETAILED DESCRIPTION

In order to clarify purposes, technical solutions, and advantages of embodiments of the present disclosure, a clear and complete description of technical solutions in embodiments of the present disclosure will be provided in the following in conjunction with the drawings. Obviously, the embodiments described are some embodiments of the present disclosure, not all of them. Based on the embodiments of the present disclosure, all other embodiments obtained by those skilled in the art without creative efforts fall within the protection scope of the present disclosure.

Screen interfaces for applications on mobile devices (such as smartphones, tablets, etc.) usually include multiple adapted controls that spread all over the screen. In the case where a conversion between a horizontal screen and a vertical screen of the mobile device occurs, if there are only several controls on the screen interface, the conversion between horizontal and vertical screens can be automatically adapted without any additional processing. However, if there are many controls on the screen interface, additional adjustments and processing are needed.

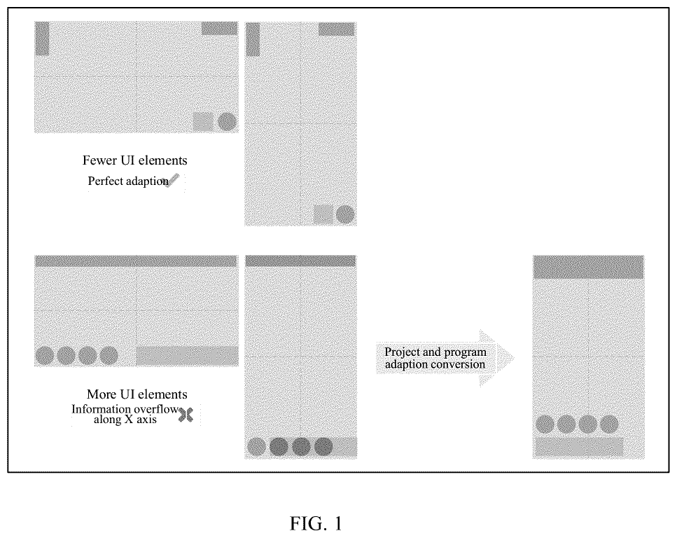

In some embodiments, most of horizontal screen interfaces in existing strategy games spread all over the screen to achieve the adaption to the screen of the terminal, making it difficult to be converted to a vertical screen interface. Even if a vertical solution for the vertical screen interface is designed, various problems would still be encountered in the implementation and development process. The various problems include, for example, the node conversion is complex, the adaptation rules are chaotic, and sizes of controls are mismatched. FIG. 1 is a schematic diagram of the screen conversion, which shows that when there are fewer control elements on the horizontal screen interface, the conversion to the vertical screen interface can be achieved directly through automatic nine-box grid adaptation without additional processing. When there are many control elements on the horizontal screen interface, the conversion to the vertical screen interface would cause that the information along the horizontal direction cannot be accommodated, which may result in overlapping of the information. The processing means in such situation usually involves manually pre-splicing and pre-positioning the vertical and horizontal screen interfaces. During the conversion between horizontal and vertical screens, each control will be adjusted, including adjusting the position and the size of the control, according to the preset splicing and positioning to meet the preset arrangement.

However, in the case where there are many controls on the screen interface, rules of the adaptation program after the conversion are usually complex. The codes contained in the adaptation program change with values of the size and displacement of the control. When there are much changes in the size and displacement of the control during the screen conversion process, the conversion efficiency would be reduced, and the development and maintenance costs would be high. Embodiments of the present disclosure provide a display control method, a display control apparatus, and an electronic device, which can be applied to a terminal device with a developed screen conversion function.

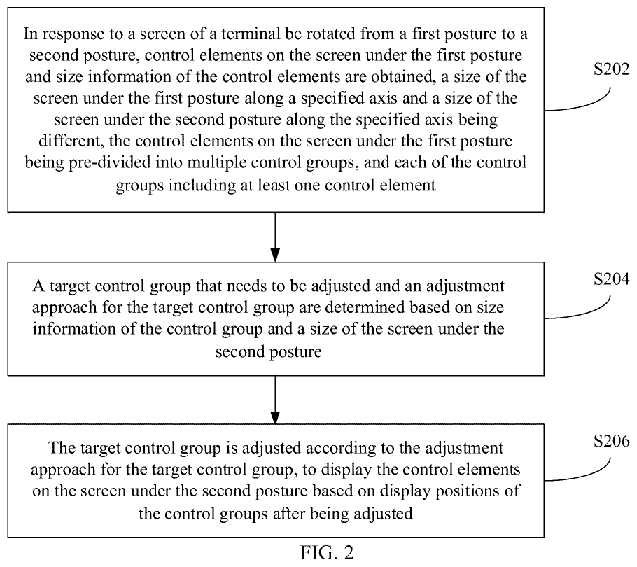

For the convenience of understanding the present disclosure, a detailed introduction to the display control method according to embodiments of the present disclosure is first provided. As shown in FIG. 2, the method includes following steps.

In step S202, in response to a screen of a terminal be rotated from a first posture to a second posture, control elements on the screen under the first posture and size information of the control elements are obtained. In some embodiments, a size of the screen under the first posture along a specified axis and a size of the screen under the second posture along the specified axis are different. The control elements on the screen under the first posture are pre-divided into multiple control groups, and each of the control groups includes at least one control element.

The screen of the terminal can be rotated from the first posture to the second posture, which can be that a device (such as a mobile phone or a tablet) is converted to a vertical screen from a horizontal screen, or converted to the horizontal screen from the vertical screen. Usually, a length of the horizontal screen along an X-axis (a horizontal direction) is greater than a length of the vertical screen along the X-axis, and a length of the horizontal screen along a Y-axis (a vertical direction) is smaller than a length of the vertical screen along the Y-axis. The above control elements can a click-triggered control or a control that does not respond to triggering operations and is for display only. The above size information of the control elements usually refers to length information and width information of the control elements on the screen under the first posture.

Due to the inclusion of multiple control elements on the screen, in order to simplify the conversion process, control elements with the same attributes and located in the preset area can be divided into the same control group in advance, based on position information and attribute information of each control element on the screen under the first posture. In some embodiments, control elements that are located in the same area and have the same attributes, or control elements that have associations with each other, can be grouped together and determined as a control group. In some embodiments, the screen usually includes multiple control groups. For example, the screen is divided into 8 areas on average, and control elements in each area are determined as a control group. Alternatively, the screen is divided into multiple areas based on the attributes of the control elements, and control elements in each area are determined as a control group.

In some embodiments, when a terminal device (a mobile phone or a tablet) activates an interface of a target application, the handheld mode of the device may be changed. For example, a vertical handheld device is converted to a horizontal handheld device, or a horizontal handheld device is converted to a vertical handheld device, which can trigger the conversion operation from the first posture to the second posture. Multiple control groups, control elements in the control groups, and size information of the control elements, can be obtained from the screen under the first posture. The size information of the control elements also includes size information of the control groups.

In step S204, a target control group that needs to be adjusted and an adjustment approach for the target control group are determined based on size information of the control group and a size of the screen under the second posture.

The above control group not only includes the control group itself, but also the control elements within the control group. Therefore, the above size information of the control group includes not only the size information of the control group itself, but also the size information of the control elements in the control group. The above adjustment approach usually includes position adjustment, size adjustment (including rotating the control elements), transparency adjustment, color adjustment, etc. The specific adjustment approach needs to be determined according to actual needs.

To reduce the complexity of the program, the size of the control group can be determined first, and then whether overflow will occur is determined, that is, whether overflow will occur when the control group is displayed on the screen under the second posture directly based on the size information of the control group under the first posture. If the overflow occurs, the control group is determined as the target control group that needs to be adjusted, and then the adjustment approach for the control elements is determined based on the way on which the control elements included in the target control group overflow. In some embodiments, if the overflow occurs when the control element is displayed on the screen under the second posture directly based on the size information of the control element under the first posture, it indicates that the control element needs to be resized. The simplest adjustment approach is to reduce the size of the control element. In some embodiments, in the case where the horizontal screen is converted to the vertical screen, if two control elements are displayed horizontally and side by side on the horizontal screen, and if the overflow occurs when the two control elements are displayed on the screen under the second posture directly based on the size information under the first posture, the positions of the two control elements can be adjusted, and the simplest adjustment approach is to vertically arrange and display these two control elements.

It should be noted that if the control group includes multiple control elements, when adjusting the position, it may also be necessary to adjust the size(s) of some control element(s), for the purpose of neat and beautiful display effects, or in order to ensure that overflow does not occur under another corresponding axis after position adjustment.

In step S206, the target control group is adjusted according to the adjustment approach for the target control group, to display the control elements on the screen under the second posture based on display positions of the control groups after being adjusted.

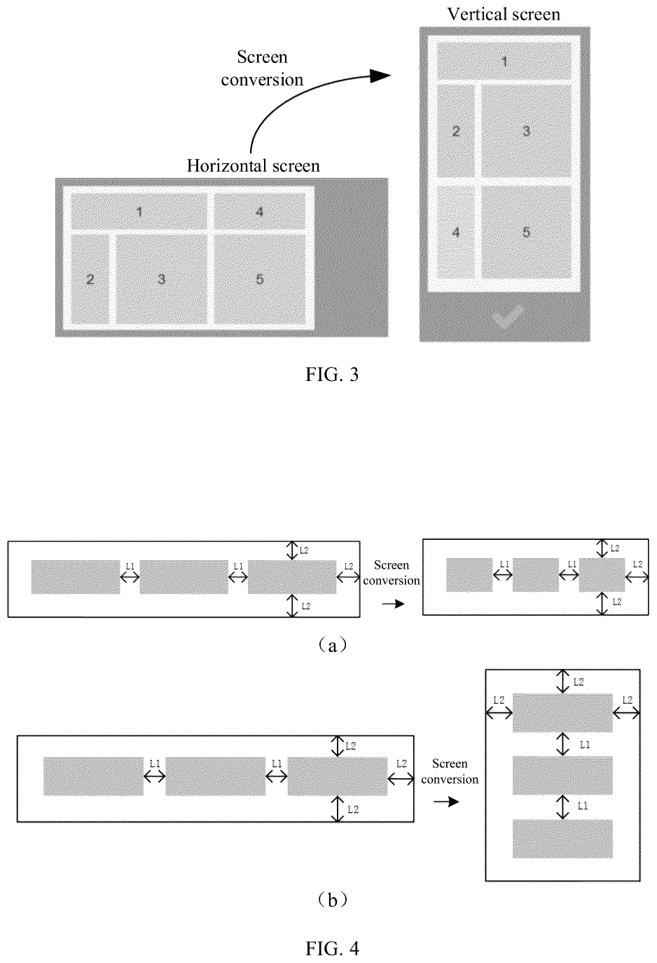

FIG. 3 is a schematic diagram of a screen conversion of a terminal. As shown in FIG. 3, the first posture (horizontal screen) is converted to the second posture (vertical screen), and the description is provided taking inclusion by the horizontal screen one control group and 5 control elements in the control group as an example. Since the control elements may overflow if they are displayed on the vertical screen directly based on the sizes on the horizontal screen, the adjustment approach for the control elements is determined to be the position adjustment. In some embodiments, the program intelligently determines that an effective adaption to the screen is carried out through an adaption with the minimal changes to the layout nodes on the interface. Then the control elements displayed on the vertical screen are obtained, as shown in FIG. 3, where only the positions of control elements 4 and 5 are changed, and the rotation adjustment is made to control element 4 at the same time, for aesthetics. The adaptation scheme with the minimal changes to the control elements is used for the conversion, and the display position of each control element in the vertical screen is obtained.

In some embodiments, the detection will also be performed through automatic calculation. If there are too many changes to the control elements, an alert will be issued to cause re-adjustment and adaption. The conversion was ultimately carried out using an adaptation scheme with the minimal changes to the control elements, avoiding the problem of doubling development costs due to excessive codes.

According to the embodiments of the present disclosure, a display control method is provided. In response to the screen of the terminal being rotated from the first posture to the second posture, the control elements on the screen under the first posture and the size information of the control elements are obtained. The control elements on the screen under the first posture are pre-divided into multiple control groups. Each of the control groups includes at least one control element. The target control group that needs to be adjusted and the adjustment approach for the target control group are determined based on the size information of the control group and the size of the screen under the second posture. The target control group is adjusted according to the adjustment approach, to display the control elements on the screen under the second posture. The display control method according to the embodiments of the present disclosure divides the control elements on the screen in advance, to obtain multiple control groups, and determines based on the control group as a unit, the target control group that needs to be adjusted and the adjustment approach. As a result, only the adjustment to the target control group is required, and the conversion is carried out through the adaptation approach with the minimal changes to the control elements, thereby reducing the complexity of the conversion and the amount of program codes, improving the conversion efficiency of the screen, and reducing development and maintenance costs.

In order to further simplify the control layout and save unnecessary codes, the above control group can be determined as a parent control element in advance, and the control elements in the control group are determined as child control elements of the parent control element. In some embodiments, after the control group is determined as the parent control element, and the control elements in the control group are determined as the child control elements, the positions of the control elements in the control group can change with the position of the control group. That is, the child control elements always change their positions according to the position of the parent control element. For example, in HTML, the control group can be set as an <HTML> element, and the control elements in the control group can be set as <body> or <head> elements, so as to set the control group as the parent control element and set the control elements as the child control element of the parent control element. Alternatively, the control group is set as the <body> or <head> element, and the control elements are set as <ul> or <p> elements, so as to set the control group as the parent control element and set the control elements as the child control element of the parent control element. When the screen conversion is carried out, the conversion can be achieved by changing the parent control element while keeping the child control element unchanged as far as possible, as shown in FIG. 3, which is converted from the horizontal screen to the vertical screen.

The following embodiments describe the step of determining, based on the size information of the control group and the size of the screen under the second posture, the target control group that needs to be adjusted and the adjustment approach for the target control group.

(1) If a size of the parent control element along the specified direction is greater than the size of the screen under the second posture along the specified direction, the parent control element is determined as a target parent control element. In some embodiments, if the screen under the first posture is horizontal and the screen under the second posture is vertical, the specified direction is the horizontal direction. If the screen under the first posture is vertical, and the screen under the second posture is horizontal, the specified direction is the vertical direction.

In the embodiments, the description is provided taking the conversion from the horizontal screen to the vertical screen as an example. It is determined first whether the length of the parent control element along the horizontal direction is greater than the length of the screen under the second posture along the horizontal direction. If the length of the parent control element is greater than the length of the screen, it indicates that the parent control element needs to be adjusted, and the parent control element is determined as the target parent control element. If the length of the parent control element is smaller than the length of the screen, it indicates that the parent control element does not need to be adjusted.

(2) A target child control element that needs to be adjusted and an adjustment approach for the target child control element are determined based on the size information of the child control element of the target parent control element and the size of the screen under the second posture.

In the embodiments, in order to minimize the number of the control elements to be adjusted, during the screen conversion process, the program automatically determines, based on the size information of the child control element of the target parent control element and the size of the screen under the second posture, the target child control element that needs to be adjusted of the target parent control element. The above adjustment approach is an actually automatic layout means, including automatic position adjustment, automatic size adjustment, and other adjustment approach.

According to the above embodiments, the parent control element that needs to be adjusted is first determined, and then the adjustment approach for the target child control element that needs to be adjusted of the target parent control element is determined, so as to adjust the layout of the target child control element based on the parent control element (in the control group). As a result, the adjustment approach with the minimal changes can be obtained, thereby saving unnecessary codes and further improving the conversion efficiency of the screen.

There are generally two situations where the control elements would overflow when the screen conversion is carried out, one is that the size of the child control element itself is relatively large, and the other is that there are problems in the layout of the control elements, resulting in a large size of the parent control element composed of the child control elements. Therefore, in order to further improve the conversion efficiency of the screen, the step (2) of determining, based on the size information of the child control element of the target parent control element and the size of the screen under the second posture, the target child control element that needs to be adjusted and the adjustment approach for the target child control element, can also be achieved according to following embodiments.

If the size of the child control element along the specified direction is greater than the size of the screen under the second posture along the specified direction, the child control element is determined as a first target child control element, and the adjustment approach for the first target child control element is determined as size adjustment.

In some embodiments, the description is provided taking the conversion from the horizontal screen to the vertical screen as an example. It is determined first whether there is a child control element among the child control elements of the target parent control element, which has a length along the horizontal direction greater than the length of the screen under the second posture along the horizontal direction. If there is a child control element that has the length greater than the length of the screen, this child control element is determined as the first target child control element. The above size adjustment can be reducing the length of the first target child control element along the horizontal direction. In some embodiments, the height can also be adjusted as necessary according to the layout needs. In this way, the adjustment approach can be classified, so as to determine the first target child control element that needs to be adjusted in size, further reducing the complexity of the conversion program.

In some embodiments, the step (2) of determining, based on the size information of the child control element of the target parent control element and the size of the screen under the second posture, the target child control element that needs to be adjusted and the adjustment approach for the target child control element, can also be achieved according to following embodiments.

If a sum of sizes of multiple child control elements located at the same specified position along the specified direction is greater than the size of the screen under the second posture along the specified direction, the multiple child control elements are determined as second target child control elements, and the adjustment approach for the second target child control elements is determined as position adjustment.

The above same specified position can be the position at the same horizontal level or the position with the same height. In some embodiments, the description is provided taking the conversion from the horizontal screen to the vertical screen as an example. In the case where the above same specified position is the position with the same height, it is determined whether there are child control elements located at the position with the same height among the child control elements of the target parent control element, a sum of the lengths of which along the horizontal direction greater than the length of the screen under the second posture along the horizontal direction. If there are child control elements, of which a sum of the lengths is greater than the length of the screen under the second posture, these child control elements are determined as the second target child control elements. The above position adjustment can be automatic layout, which aims to minimize the number of adjusted child control elements. In this way, the adjustment approach can be classified, so as to determine the second target child control element that needs to be adjusted in position, further reducing the complexity of the conversion program.

As shown in FIG. 3, the sum of the lengths of the child control elements “1” and “4” on the horizontal screen along the horizontal direction is greater than the size of the vertical screen along the horizontal direction, and thus the adjustment approach for the child control elements “1” and “4” is determined as position adjustment. In the actual adjustment, in order to minimize as far as possible the number of the child control elements to be adjusted, it is possible to change the position of the child control element “4” only. In addition, as shown in FIG. 3, the sum of the lengths of the child control elements “2”, “3”, and “5” in the second row is greater than the size of the vertical screen along the horizontal direction, and thus the adjustment approach for the child control elements “2”, “3”, and “5” is determined as position adjustment. In the actual adjustment, in order to minimize as far as possible the number of the child control elements to be adjusted, it is possible to change the position of the child control element “5” only.

In order to ensure the adjustment approach of changing the parent control element while keeping the child control element unchanged as far as possible, the above parent control element is set to a dynamically filled container. A first specified edge spacing between adjacent child control elements of the parent control element remains unchanged, and a second specified edge spacing between an inner edge of the parent control element and the child control element adjacent to the parent control element remains unchanged, so that the relative position of the child control element of the parent control element (in the control group) remains unchanged.

When adjusting the size and the position of the child control element of the parent control element (in the control group) through the automatic layout, in order to ensure that the parent control element can be adjusted with the adjustment of the child control element when adjusting the child control element, the first specified edge spacing between the child control elements can be set to remain unchanged. As shown in FIG. 4, the spacing L1 between adjacent edges of two adjacent child control elements remains unchanged. Also as shown in FIG. 4, the spacing L2 between the inner edge of the parent control element and the edge of the child control element adjacent to the parent control element remains unchanged.

According to the above embodiments, the parent control element can be adjusted simultaneously, correspondingly during the adjustment process of the child control element. As shown in FIG. 4(a), when the length of the child control element is changed, the first specified edge spacing L1 and the second specified edge spacing L2 remain unchanged. Also as shown in FIG. 4(b), when the arrangement position of the child control element is changed, the first specified edge spacing L1 and the second specified edge spacing L2 still remain unchanged. As a result, the effect of keeping the relative position of the child control element of the parent control element (in the control group) unchanged can be achieved.

According to the above embodiments, by setting a fixed spacing between the parent control element and the child control element, the effect of keeping the relative position of the child control element of the parent control element (in the control group) unchanged is achieved, further reducing the complexity of the automatic layout by the program and improving the conversion efficiency of the screen.

In some embodiments, the above target control group includes a first target child control element and a second target child control element. The step of adjusting the target control group according to the adjustment approach for the target control group can be realized according to following embodiments.

According to an automatic layout approach, a size of the first target child control element is adjusted, and a position of the second target child control element is adjusted, so that the size of the first target child control element along the specified direction is smaller than the size of the screen under the second posture along the specified direction, and so that the sum of sizes of the second target child control elements located at the same specified position along the specified direction is smaller than the size of the screen under the second posture along the specified direction.

After the target child control element that needs to be adjusted and the adjustment approach are determined, the size of the first target child control element can be automatically adjusted, and the position of the second target child control element can be adjusted, according to the automatic layout approach defined by the program, with the automatic layout approach aiming for the minimum number of child control elements to be adjusted and the adjusted layout meeting the preset layout condition, so that the size of the first target child control element along the specified direction is smaller than the size of the screen under the second posture along the specified direction, the sum of sizes of the second target child control elements located at the same specified position along the specified direction is smaller than the size of the screen under the second posture along the specified direction, and the control elements after being adjusted will not overlap or overflow. In this way, the target child control elements are adjusted through automatic layout, not only saving development costs but also ensuring the consistency, uniformity, and readability of the horizontal and vertical screen interfaces, which is more in line with user habits.

In order to ensure that the finally obtained control elements do not overflow or overlap, after adjusting the position of the second target child control element, the above method further includes: if the sum of the sizes of the adjusted second target child control elements located at the same specified position along the specified direction is greater than the size of the screen under the second posture along the specified direction, adjusting the sizes of the adjusted second target child control elements.

If the child control element that is horizontally arranged is adjusted to be vertically arranged, there may be a situation where the height of the child control element along the vertical direction is greater than the height of the screen under the second posture along the vertical direction. Therefore, it is necessary to make the determination on this and adjust the size of the child control element that is vertically arranged, to ensure that the final layout of the child control elements meets the requirements without causing overflow issues. In this way, whether the overflow will occur is further determined, which can ensure the quality of the control elements on the screen under the second posture after the conversion.

According to the above embodiments, the automatic determination and adaptation are adopted during the conversion between the horizontal and vertical screen interfaces, which effectively saves program development costs, solves the problem of difficult conversion between the horizontal and vertical screen interfaces in SLG, improves the design efficiency, and improves the conversion efficiency and implementation efficiency of horizontal and vertical screens, not only saving development costs but also ensuring the consistency, uniformity, and readability of the horizontal and vertical screen interfaces, which is more in line with user habits.

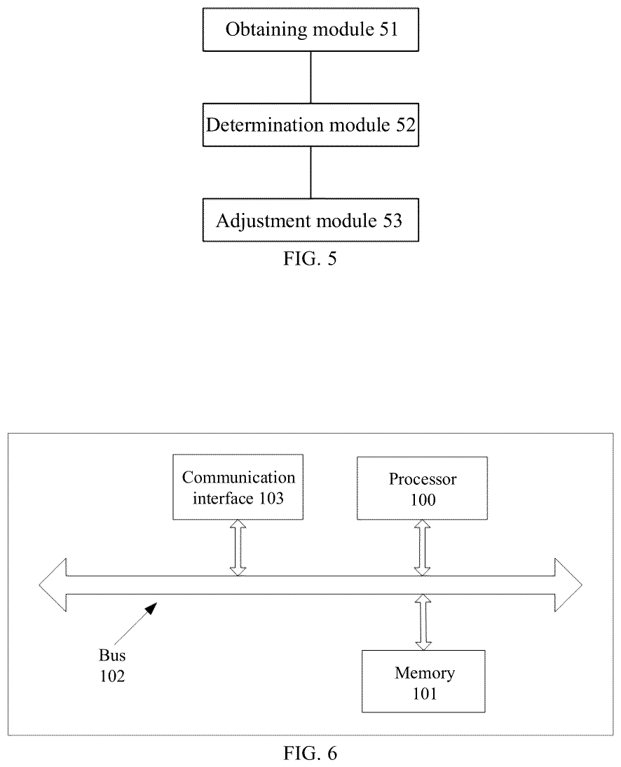

Based on the above method embodiments, embodiments of the present disclosure also provide a display control apparatus, as shown in FIG. 5. The display control apparatus includes an obtaining module 51, a determination module 52, and an adjustment module 53.

The obtaining module 51 is configured to obtain, in response to a screen of a terminal being converted from a first posture to a second posture, control elements on the screen under the first posture and size information of the control elements. In some embodiments, a size of the screen under the first posture along a specified axis and a size of the screen under the second posture along the specified axis are different, the control elements on the screen under the first posture are pre-divided into multiple control groups, and each control group includes at least one of the control elements.

The determination module 52 is configured to determine, based on size information of the control group and the size of the screen under the second posture, a target control group that needs to be adjusted and an adjustment approach for the target control group.

The adjustment module 53 is configured to adjust the target control group according to the adjustment approach for the target control group, to display the control elements on the screen under the second posture based on display positions of the multiple control groups after being adjusted.

According to the embodiments of the present disclosure, a display control apparatus is provided. In response to the screen of the terminal being rotated from the first posture to the second posture, the control elements on the screen under the first posture and the size information of the control elements are obtained. The control elements on the screen under the first posture are pre-divided into multiple control groups. Each of the control groups includes at least one control element. The target control group that needs to be adjusted and the adjustment approach for the target control group are determined based on the size information of the control group and the size of the screen under the second posture. The target control group is adjusted according to the adjustment approach, to display the control elements on the screen under the second posture. The display control method according to the embodiments of the present disclosure divides the control elements on the screen in advance, to obtain multiple control groups, and determines based on the control group as a unit, the target control group that needs to be adjusted and the adjustment approach. As a result, only the adjustment to the target control group is required, and the conversion is carried out through the adaptation approach with the minimal changes to the control elements, thereby reducing the complexity of the conversion and the amount of program codes, improving the conversion efficiency of the screen, and reducing development and maintenance costs.

In some embodiments, the above control group is a parent control element, and the control element in the control group is a child control element of the parent control element. The above determination module is further configured to: determine, in response to a size of the parent control element along a specified direction being greater than the size of the screen under the second posture along the specified direction, the parent control element as a target parent control element; in the case where the screen under the first posture is horizontal and the screen under the second posture is vertical, the specified direction is a horizontal direction, and in the case where the screen under the first posture is vertical and the screen under the second posture is horizontal, the specified direction is a vertical direction; and determine, based on size information of the child control element of the target parent control element and the size of the screen under the second posture, a target child control element that needs to be adjusted and an adjustment approach for the target child control element.

In some embodiments, the above determination module is further configured to: determine, in response to a size of the child control element along the specified direction being greater than the size of the screen under the second posture along the specified direction, the child control element as a first target child control element; and determine the adjustment approach for the first target child control element as size adjustment.

In some embodiments, the above determination module is further configured to: determine, in response to a sum of sizes of multiple child control elements located at the same specified position along the specified direction being greater than the size of the screen under the second posture along the specified direction, the multiple child control elements as second target child control elements; and determine the adjustment approach for the second target child control elements as position adjustment.

In some embodiments, the above parent control element is a dynamically filled container, a first specified edge spacing between adjacent child control elements of the above parent control element remains unchanged, and a second specified edge spacing between an inner edge of the parent control element and the child control element adjacent to the parent control element remains unchanged.

In some embodiments, the above target control group includes a first target child control element and a second target child control element. The above adjustment module is further configured to: adjust, according to an automatic layout approach, a size of the first target child control element and a position of the second target child control element, to enable the size of the first target child control element along a specified direction to be smaller than the size of the screen under the second posture along the specified direction, and to enable a sum of sizes of second target child control elements located at the same specified position along the specified direction to be smaller than the size of the screen under the second posture along the specified direction.

In some embodiments, the above apparatus further includes a second adjustment module, which is configured to: adjust, in response to the sum of the sizes of the second target child control elements located at the same specified position along the specified direction being greater than the size of the screen under the second posture along the specified direction, the sizes of the second target child control elements after being adjusted.

In some embodiments, the above apparatus further includes a grouping module, which is configured to: divide control elements with the same attributes and located in a preset area into the same control group according to position information and attribute information of each control element on the screen under the first posture.

The display control apparatus according to the embodiments of the present disclosure, in response to the screen of the terminal being rotated from the first posture to the second posture, the control elements on the screen under the first posture and the size information of the control elements are obtained. The control elements on the screen under the first posture are pre-divided into multiple control groups. Each of the control groups includes at least one control element. The target control group that needs to be adjusted and the adjustment approach for the target control group are determined based on the size information of the control group and the size of the screen under the second posture. The target control group is adjusted according to the adjustment approach, to display the control elements on the screen under the second posture. The display control method according to the embodiments of the present disclosure divides the control elements on the screen in advance, to obtain multiple control groups, and determines based on the control group as a unit, the target control group that needs to be adjusted and the adjustment approach. As a result, only the adjustment to the target control group is required, and the conversion is carried out through the adaptation approach with the minimal changes to the control elements, thereby reducing the complexity of the conversion and the amount of program codes, improving the conversion efficiency of the screen, and reducing development and maintenance costs.

The display control apparatus provided in embodiments of the present disclosure has the same technical features as the display control method provided in the above embodiments, which can also solve the same technical problem and achieve the same technical effect.

Embodiments of the present disclosure also provide an electronic device including a processor and a memory. The memory stores computer executable instructions that can be executed by the processor. The processor executes the computer executable instructions to cause the above display control method to be implemented. The electronic device can be a server or a terminal device.

As shown in FIG. 6, the electronic device includes a processor 100 and a memory 101. The memory 101 stores computer executable instructions that can be executed by the processor 100. The processor 100 executes the computer executable instructions to cause the above display control method to be implemented.

In some embodiments, the electronic device shown in FIG. 6 further includes a bus 102 and a communication interface 103, and the processor 100, the communication interface 103, and memory 101 are connected through the bus 102.

In some embodiments, the memory 101 may include the high-speed random access memory (RAM), as well as the non-volatile memory, such as at least one disk storage. The communication connection between the system network element and at least one other network element is realized through at least one communication interface 103 (which can be wired or wireless), where the Internet, the wide area network, the local wide area network, the metropolitan area network, etc., can be used. The bus 102 can be an ISA bus, a PCI bus, or an EISA bus, etc. The bus can be divided into the address bus, the data bus, the control bus, etc. For ease of representation, only one bidirectional arrow is used in FIG. 6, but it does not mean that there is only one bus or one type of bus.

The processor 100 may be an integrated circuit chip with signal processing capability. In the implementation process, each step of the above methods can be completed through the integrated logic circuit of the hardware or software instructions in the processor 100. The above processor 100 can be a general-purpose processor, including a central processing unit (CPU), a network processor (NP), etc. It can also be a digital signal processor (DSP for short), an application specific integrated circuit (ASIC), a field programmable gate array (FPGA), or other programmable logic devices, discrete gates or transistor logic devices, or discrete hardware components. The methods, steps, and logical diagrams disclosed in embodiments of the present disclosure can be implemented or executed. The general-purpose processor can be a microprocessor or any conventional processor. The steps of the methods disclosed in embodiments of the present disclosure can be directly embodied in the achievement by the hardware decoding processor or the combination of hardware and software modules in the decoding processor. Software modules can be located in mature storage media in in the RAM, flash memory, read-only memory, programmable read-only memory or electrically erasable programmable memory. The storage medium is located in the memory 101, and the processor 100 reads the information in the memory 101 and completes the steps of the methods described in the aforementioned embodiments in combination with its hardware.

Embodiments of the present disclosure provide an electronic device, which obtains, in response to a screen of a terminal being converted from a first posture to a second posture, control elements on the screen under the first posture and size information of the control elements, with a size of the screen under the first posture along a specified axis and a size of the screen under the second posture along the specified axis being different, the control elements on the screen under the first posture being pre-divided into multiple control groups, and each control group including at least one of the control elements; determines, based on size information of the control group and the size of the screen under the second posture, a target control group that needs to be adjusted and an adjustment approach for the target control group; and adjusts the target control group according to the adjustment approach for the target control group, to display the control elements on the screen under the second posture based on display positions of the multiple control groups after being adjusted.

In some embodiments of the present disclosure, based on the scheme in aforementioned embodiments, the control group is a parent control element, and the control element in the control group is a child control element of the parent control element. The step of determining, based on the size information of the control group and the size of the screen under the second posture, the target control group that needs to be adjusted and the adjustment approach for the target control group, includes: determining, in response to a size of the parent control element along a specified direction being greater than the size of the screen under the second posture along the specified direction, the parent control element as a target parent control element. In the case where the screen under the first posture is horizontal and the screen under the second posture is vertical, the specified direction is a horizontal direction, and in the case where the screen under the first posture is vertical and the screen under the second posture is horizontal, the specified direction is a vertical direction; and determining, based on size information of the child control element of the target parent control element and the size of the screen under the second posture, a target child control element that needs to be adjusted and an adjustment approach for the target child control element.

In some embodiments of the present disclosure, based on the scheme in aforementioned embodiments, the step of determining, based on the size information of the child control element of the target parent control element and the size of the screen under the second posture, the target child control element that needs to be adjusted and the adjustment approach for the target child control element, includes: determining, in response to a size of the child control element along the specified direction being greater than the size of the screen under the second posture along the specified direction, the child control element as a first target child control element; and determining the adjustment approach for the first target child control element as size adjustment.

In some embodiments of the present disclosure, based on the scheme in aforementioned embodiments, the step of determining, based on the size information of the child control element of the target parent control element and the size of the screen under the second posture, the target child control element that needs to be adjusted and the adjustment approach for the target child control element, includes: determining, in response to a sum of sizes of multiple child control elements located at the same specified position along the specified direction being greater than the size of the screen under the second posture along the specified direction, the multiple child control elements as second target child control elements; and determining the adjustment approach for the second target child control elements as position adjustment.

In some embodiments of the present disclosure, based on the scheme in aforementioned embodiments, the parent control element is a dynamically filled container, a first specified edge spacing between adjacent child control elements of the parent control element remains unchanged, and a second specified edge spacing between an inner edge of the parent control element and the child control element adjacent to the parent control element remains unchanged.

In some embodiments of the present disclosure, based on the scheme in aforementioned embodiments, the target control group includes a first target child control element and a second target child control element. The step of adjusting the target control group according to the adjustment approach for the target control group, includes: adjusting, according to an automatic layout approach, a size of the first target child control element and a position of the second target child control element, to enable the size of the first target child control element along a specified direction to be smaller than the size of the screen under the second posture along the specified direction, and to enable a sum of sizes of second target child control elements located at the same specified position along the specified direction to be smaller than the size of the screen under the second posture along the specified direction.

In some embodiments of the present disclosure, based on the scheme in aforementioned embodiments, after the step of adjusting the position of the second target child control element, the method further includes: adjusting, in response to the sum of the sizes of the second target child control elements located at the same specified position along the specified direction being greater than the size of the screen under the second posture along the specified direction, the sizes of the second target child control elements after being adjusted.

In some embodiments of the present disclosure, based on the scheme in aforementioned embodiments, the control elements on the screen under the first posture are pre-divided into multiple control groups by dividing control elements with the same attributes and located in a preset area into the same control group according to position information and attribute information of each control element on the screen under the first posture.

The electronic device according to the embodiments of the present disclosure, in response to the screen of the terminal being rotated from the first posture to the second posture, the control elements on the screen under the first posture and the size information of the control elements are obtained. The control elements on the screen under the first posture are pre-divided into multiple control groups. Each of the control groups includes at least one control element. The target control group that needs to be adjusted and the adjustment approach for the target control group are determined based on the size information of the control group and the size of the screen under the second posture. The target control group is adjusted according to the adjustment approach, to display the control elements on the screen under the second posture. The display control method according to the embodiments of the present disclosure divides the control elements on the screen in advance, to obtain multiple control groups, and determines based on the control group as a unit, the target control group that needs to be adjusted and the adjustment approach. As a result, only the adjustment to the target control group is required, and the conversion is carried out through the adaptation approach with the minimal changes to the control elements, thereby reducing the complexity of the conversion and the amount of program codes, improving the conversion efficiency of the screen, and reducing development and maintenance costs.

Embodiments of the present disclosure also provide a computer-readable storage medium, which stores computer executable instructions. When the computer executable instructions are called and executed by a processor, the computer executable instructions cause the processor to implement the display control methods described above.

Embodiments of the present disclosure provide a computer-readable storage medium, which obtains, in response to a screen of a terminal being converted from a first posture to a second posture, control elements on the screen under the first posture and size information of the control elements, with a size of the screen under the first posture along a specified axis and a size of the screen under the second posture along the specified axis being different, the control elements on the screen under the first posture being pre-divided into multiple control groups. and each control group including at least one of the control elements; determines, based on size information of the control group and the size of the screen under the second posture, a target control group that needs to be adjusted and an adjustment approach for the target control group; and adjusts the target control group according to the adjustment approach for the target control group, to display the control elements on the screen under the second posture based on display positions of the multiple control groups after being adjusted.

In some embodiments of the present disclosure, based on the scheme in aforementioned embodiments, the control group is a parent control element, and the control element in the control group is a child control element of the parent control element. The step of determining, based on the size information of the control group and the size of the screen under the second posture, the target control group that needs to be adjusted and the adjustment approach for the target control group, includes: determining, in response to a size of the parent control element along a specified direction being greater than the size of the screen under the second posture along the specified direction, the parent control element as a target parent control element. In the case where the screen under the first posture is horizontal and the screen under the second posture is vertical, the specified direction is a horizontal direction, and in the case where the screen under the first posture is vertical and the screen under the second posture is horizontal, the specified direction is a vertical direction; and determining, based on size information of the child control element of the target parent control element and the size of the screen under the second posture, a target child control element that needs to be adjusted and an adjustment approach for the target child control element.

In some embodiments of the present disclosure, based on the scheme in aforementioned embodiments, the step of determining, based on the size information of the child control element of the target parent control element and the size of the screen under the second posture, the target child control element that needs to be adjusted and the adjustment approach for the target child control element, includes: determining, in response to a size of the child control element along the specified direction being greater than the size of the screen under the second posture along the specified direction, the child control element as a first target child control element; and determining the adjustment approach for the first target child control element as size adjustment.

In some embodiments of the present disclosure, based on the scheme in aforementioned embodiments, the step of determining, based on the size information of the child control element of the target parent control element and the size of the screen under the second posture, the target child control element that needs to be adjusted and the adjustment approach for the target child control element, includes: determining, in response to a sum of sizes of multiple child control elements located at the same specified position along the specified direction being greater than the size of the screen under the second posture along the specified direction, the multiple child control elements as second target child control elements; and determining the adjustment approach for the second target child control elements as position adjustment.

In some embodiments of the present disclosure, based on the scheme in aforementioned embodiments, the parent control element is a dynamically filled container, a first specified edge spacing between adjacent child control elements of the parent control element remains unchanged, and a second specified edge spacing between an inner edge of the parent control element and the child control element adjacent to the parent control element remains unchanged.

In some embodiments of the present disclosure, based on the scheme in aforementioned embodiments, the target control group includes a first target child control element and a second target child control element. The step of adjusting the target control group according to the adjustment approach for the target control group, includes: adjusting, according to an automatic layout approach, a size of the first target child control element and a position of the second target child control element, to enable the size of the first target child control element along a specified direction to be smaller than the size of the screen under the second posture along the specified direction, and to enable a sum of sizes of second target child control elements located at the same specified position along the specified direction to be smaller than the size of the screen under the second posture along the specified direction.

In some embodiments of the present disclosure, based on the scheme in aforementioned embodiments, after the step of adjusting the position of the second target child control element, the method further includes: adjusting, in response to the sum of the sizes of the second target child control elements located at the same specified position along the specified direction being greater than the size of the screen under the second posture along the specified direction, the sizes of the second target child control elements after being adjusted.

In some embodiments of the present disclosure, based on the scheme in aforementioned embodiments, the control elements on the screen under the first posture are pre-divided into multiple control groups by dividing control elements with the same attributes and located in a preset area into the same control group according to position information and attribute information of each control element on the screen under the first posture.

The computer-readable storage medium according to the embodiments of the present disclosure, in response to the screen of the terminal being rotated from the first posture to the second posture, the control elements on the screen under the first posture and the size information of the control elements are obtained. The control elements on the screen under the first posture are pre-divided into multiple control groups. Each of the control groups includes at least one control element. The target control group that needs to be adjusted and the adjustment approach for the target control group are determined based on the size information of the control group and the size of the screen under the second posture. The target control group is adjusted according to the adjustment approach, to display the control elements on the screen under the second posture. The display control method according to the embodiments of the present disclosure divides the control elements on the screen in advance, to obtain multiple control groups, and determines based on the control group as a unit, the target control group that needs to be adjusted and the adjustment approach. As a result, only the adjustment to the target control group is required, and the conversion is carried out through the adaptation approach with the minimal changes to the control elements, thereby reducing the complexity of the conversion and the amount of program codes, improving the conversion efficiency of the screen, and reducing development and maintenance costs.

The computer program products of the display control method, display control apparatus, electronic device, and system provided in embodiments of the present disclosure include a computer-readable storage medium that stores program codes. The instructions included in the program codes can be used to execute the methods described in the previous method embodiments. The specific implementation can be found in the method embodiments, and will not be repeated here.

Those skilled in the art can clearly understand that for the convenience and conciseness of the description, the specific working process of the system and the apparatus described above can refer to the corresponding process in the aforementioned method embodiments, and will not be repeated here.

In addition, in the description of embodiments of the present disclosure, unless otherwise specified and limited, the terms “installation”, “connected”, and “connection” should be understood in the broadest sense. For example, it can be fixed connections, detachable connections, or integrated connections, or it can be a mechanical connection or an electrical connection, or it can be directly connected, or indirectly connected through an intermediate medium, or it can be an internal connection between two components. Those skilled in the art can understand the specific meanings of the above terms in the present disclosure based on specific circumstances.

If the functions are implemented in the form of software functional units and sold or used as independent products, they can be stored in a computer-readable storage medium. Based on such understanding, the substance of technical solutions of the present disclosure, or parts that contribute to the existing technology, or parts of the technical solutions can be embodied in the form of a software product. The computer software product is stored in a storage medium and includes several instructions, so as to enable a computer device (which can be a personal computer, a server, or a network device, etc.) to perform all or part of the steps of the methods described in the various embodiments of the present disclosure. The aforementioned storage medium includes: USB flash drives, portable hard drives, read-only memories (ROM), random access memories (RAM), disks or CDs, and other media that can store program codes.

In the description of the present disclosure, it should be noted that the terms, such as “center”, “up”, “down”, “left”, “right”, “vertical”, “horizontal”, “inside”, “outside”, etc., indicate that the orientation or position relationship based on the orientation or position relationship shown in the drawings, which is only for the convenience of describing and simplifying the present disclosure, and not to indicate or imply that the device or component referred to must have a specific orientation, or must be constructed and operated in a specific orientation, and therefore cannot be understood as a limitation to the present disclosure. In addition, the terms “first,” “second,” and “third” are only for the purpose of description and cannot be understood as indicating or implying relative importance.

Finally, it should be noted that the above embodiments are only specific embodiments of the present disclosure, which are used to illustrate the technical solutions of the present disclosure, rather than limiting the present disclosure. The protection scope of the present disclosure is not limited to this. Although detailed explanations of the present disclosure have been provided by referring to the aforementioned embodiments, those skilled in the art should understand that any person familiar with the art can still, within the scope of the disclosed technology, modify or easily come up with changes to the technical solutions described in the aforementioned embodiments, or make equivalent replacements to some of the technical features. These modifications, changes, or replacements do not make the substance of corresponding technical solutions deviate from the spirit and scope of the present disclosure, and should be covered within the protection scope of the present disclosure. Therefore, the protection scope of the present disclosure shall be based on the protection scope of the claims.

1. A display control method, performed by a terminal, the method comprising:
obtaining, in response to a screen of the terminal being converted from a first posture to a second posture, control elements on the screen under the first posture and size information of the control elements, wherein a first size of the screen under the first posture along a specified direction and a second size of the screen under the second posture along the specified direction are different, the control elements on the screen under the first posture are pre-divided into at least one control group, and each control group comprises at least one of the control elements;
determining, based on size information associated with the control group and the second size of the screen under the second posture, a target control group that needs to be adjusted and an adjustment approach for the target control group, wherein the size information associated with the control group comprises the size information of the control elements and size information of the control group; and
adjusting the target control group according to the adjustment approach for the target control group, to display the control elements on the screen under the second posture based on a display position of the at least one control group after being adjusted.

2. The method according to claim 1, wherein the control group is determined as a parent control element, and the control element in the control group is determined as a child control element of the parent control element, and
wherein determining, based on the size information associated with the control group and the size of the screen under the second posture, the target control group that needs to be adjusted and the adjustment approach for the target control group, comprises:
determining, in response to a size of the parent control element along the specified direction being greater than the size of the screen under the second posture along the specified direction, the parent control element as a target parent control element, wherein in the case where the screen under the first posture is horizontal and the screen under the second posture is vertical, the specified direction is a horizontal direction, and in the case where the screen under the first posture is vertical and the screen under the second posture is horizontal, the specified direction is a vertical direction; and
determining, based on size information of the child control element of the target parent control element and the size of the screen under the second posture, a target child control element that needs to be adjusted and an adjustment approach for the target child control element.

3. The method according to claim 2, wherein determining the target child control element that needs to be adjusted and the adjustment approach for the target child control element, comprises:
determining, in response to a size of the child control element along the specified direction being greater than the size of the screen under the second posture along the specified direction, the child control element as a first target child control element; and
determining the adjustment approach for the first target child control element as size adjustment.

4. The method according to claim 2, wherein determining the target child control element that needs to be adjusted and the adjustment approach for the target child control element, comprises:
determining, in response to a sum of sizes of multiple child control elements located at the same specified position along the specified direction being greater than the size of the screen under the second posture along the specified direction, the multiple child control elements as second target child control elements; and
determining the adjustment approach for the second target child control elements as position adjustment.

5. The method according to claim 2, wherein the parent control element comprises a dynamically filled container, and wherein a first specified edge spacing between adjacent child control elements of the parent control element remains unchanged, and a second specified edge spacing between an inner edge of the parent control element and the child control element adjacent to the parent control element remains unchanged.

6. The method according to claim 1, wherein the target control group comprises a first target child control element and a second target child control element, and
wherein adjusting the target control group according to the adjustment approach for the target control group, comprises:
adjusting, according to an automatic layout approach, a size of the first target child control element and a position of the second target child control element, to enable the size of the first target child control element along the specified direction to be smaller than the size of the screen under the second posture along the specified direction, and to enable a sum of sizes of second target child control elements located at the same specified position along the specified direction to be smaller than the size of the screen under the second posture along the specified direction.

7. The method according to claim 6, further comprising:
adjusting, in response to the sum of the sizes of the second target child control elements located at the same specified position along the specified direction being greater than the size of the screen under the second posture along the specified direction, the sizes of the second target child control elements after the position of the second target child control element is adjusted.

8. The method according to claim 2, wherein the control elements on the screen under the first posture are pre-divided into the at least one control group by dividing control elements with the same attributes and located in a preset area into the same control group according to position information and attribute information of each control element on the screen under the first posture.

9. (canceled)

10. An electronic device comprising a processor and a memory, wherein the memory stores computer executable instructions that can be executed by the processor, and the processor is configured to:
obtain, in response to a screen of the terminal being converted from a first posture to a second posture, control elements on the screen under the first posture and size information of the control elements, wherein a size of the screen under the first posture along a specified direction and a size of the screen under the second posture along the specified direction are different, the control elements on the screen under the first posture are pre-divided into at least one control group, and each control group comprises at least one of the control elements;
determine, based on size information associated with the control group and the size of the screen under the second posture, a target control group that needs to be adjusted and an adjustment approach for the target control group, wherein the size information associated with the control group comprises the size information of the control elements and size information of the control group; and
adjust the target control group according to the adjustment approach for the target control group, to display the control elements on the screen under the second posture based on a display position of the at least one control group after being adjusted.

11. A non-transitory computer-readable storage medium having computer executable instructions stored thereon, which when called and executed by a processor, cause the display control method according to claim 1 to be implemented.

12. The method according to claim 2, wherein the parent control element is set as an <HTML> element, and the child control element of the parent control element is set as a <body> or <head> element; or
wherein the parent control element is set as the <body> or <head> element, and the child control element of the parent control element is set as a <ul> or <p> element.

13. The method according to claim 5, wherein adjusting the target control group according to the adjustment approach for the target control group, comprises:
adjusting the parent control element with an adjustment of the child control element by setting that the first specified edge spacing and/or the second specified edge spacing remains unchanged.

14. The electronic device according to claim 10, wherein the control group is determined as a parent control element, and the control element in the control group is determined as a child control element of the parent control element, and wherein the processor is further configured to:
determine, in response to a size of the parent control element along the specified direction being greater than the size of the screen under the second posture along the specified direction, the parent control element as a target parent control element, wherein in the case where the screen under the first posture is horizontal and the screen under the second posture is vertical, the specified direction is a horizontal direction, and in the case where the screen under the first posture is vertical and the screen under the second posture is horizontal, the specified direction is a vertical direction; and
determine, based on size information of the child control element of the target parent control element and the size of the screen under the second posture, a target child control element that needs to be adjusted and an adjustment approach for the target child control element.

15. The electronic device according to claim 14, wherein the processor is further configured to:
determine, in response to a size of the child control element along the specified direction being greater than the size of the screen under the second posture along the specified direction, the child control element as a first target child control element; and
determine the adjustment approach for the first target child control element as size adjustment.

16. The electronic device according to claim 14, wherein the processor is further configured to:
determine, in response to a sum of sizes of multiple child control elements located at the same specified position along the specified direction being greater than the size of the screen under the second posture along the specified direction, the multiple child control elements as second target child control elements; and
determine the adjustment approach for the second target child control elements as position adjustment.

17. The electronic device according to claim 14, wherein the parent control element comprises a dynamically filled container, and wherein a first specified edge spacing between adjacent child control elements of the parent control element remains unchanged, and a second specified edge spacing between an inner edge of the parent control element and the child control element adjacent to the parent control element remains unchanged.

18. The electronic device according to claim 10, wherein the target control group comprises a first target child control element and a second target child control element, and wherein the processor is further configured to:
adjust, according to an automatic layout approach, a size of the first target child control element and a position of the second target child control element, to enable the size of the first target child control element along the specified direction to be smaller than the size of the screen under the second posture along the specified direction, and to enable a sum of sizes of second target child control elements located at the same specified position along the specified direction to be smaller than the size of the screen under the second posture along the specified direction.

19. The electronic device according to claim 18, wherein the processor is further configured to:
adjust, in response to the sum of the sizes of the second target child control elements located at the same specified position along the specified direction being greater than the size of the screen under the second posture along the specified direction, the sizes of the second target child control elements after the position of the second target child control element is adjusted.

20. The electronic device according to claim 14, wherein the control elements on the screen under the first posture are pre-divided into the at least one control group by dividing control elements with the same attributes and located in a preset area into the same control group according to position information and attribute information of each control element on the screen under the first posture.

21. The electronic device according to claim 14, wherein the parent control element is set as an <HTML> element, and the child control element of the parent control element is set as a <body> or <head> element; or wherein the parent control element is set as the <body> or <head> element, and the child control element of the parent control element is set as a <ul> or <p> element.
